(19) United States
(12) Patent Application Publication
(10) Pub. No.: US 2005/0239624 A1
(43) Pub. Date: Oct. 27, 2005

(54) Folding unit having a folding roller adjustment means

(75) Inventors: Georg Dannemann, Backnang (DE); Klaus Stocklossa, Marbach (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 11/109,738

(22) Filed: Apr. 20, 2005

(30) Foreign Application Priority Data
Apr. 22, 2004 (DE) 20 2004 006 387.5

(51) Int. Cl. B31F 1/00

(52) U.S. Cl. 493/421

(57) ABSTRACT

A folding unit has at least one pair of folding rollers including an adjustable folding roller and a stationary folding roller or two adjustable folding rollers. At least two pressure measuring devices are associated to one adjustable folding roller, the pressure measuring devices being arranged at a distance from one another and measuring pressure values when a sheet passes therethrough. The pressure values correspond to pressures which are exerted on said sheet by the adjustable folding roller at two measurement points which are spaced apart transversely with respect to a sheet running direction. The pressure measuring devices forward measured pressure values to a processing device. Each adjustable folding roller is connected kinematically to a corresponding drive at two connection points which are spaced apart transversely with respect to the sheet running direction. The drives are controllable by the processing device on the basis of the pressure values measured by said pressure measuring devices during the sheet pass, in order to attain an optimum roller nip width between the folding rollers.

### BACKGROUND OF THE INVENTION

1. Field of the Invention

The invention relates to a folding unit having at least one pair of folding rollers which has an adjustable and a stationary folding roller, it being possible to adjust the roller nip between the folding rollers as a function of sheet parameters using drives controlled by a processing device.

2. Description of the Background Art

EP 1 321 411 A1 has disclosed a pocket folder which has a plurality of pairs of folding rollers which are arranged one behind the other in the sheet passing direction and have at least one adjustable folding roller. The adjustable folding roller is mounted rotatably at the free end of an arm of a two-armed roller lever, which arm which can be pivoted about an axle which is fixed with respect to the machine. A restoring spring acts on the other arm of the roller lever, the adjustable folding roller being prestressed in the direction of the other folding roller by said restoring spring. Furthermore, the second arm of the roller lever is connected kinematically to a drive, in order to adjust the folding nip width between the folding rollers. Moreover, the roller lever is assigned a distance measuring system which measures the deflection of the roller lever. The drives and the distance measuring systems are connected to a processing device which controls the drives on the basis of the measured values detected by the distance measuring system. For the automatic setting of the roller nip, the drives are initially controlled by the processing device in such a way that the folding rollers of the individual pairs of folding rollers come into contact with one another, with the result that the distance of the roller nip is “0”. The roller levers are prestressed in the direction of the other folding roller by the restoring springs. For the automatic setting of the folding nip width, a sheet is passed through the pairs of folding rollers arranged one after another, in accordance with the desired folding layout. Here, the individual adjustable folding rollers are deflected in accordance with the sheet thickness. This deflection corresponds to the width of the roller nip which is optimum for processing subsequent sheets. The deflection is measured in each case by the distance measuring system and a corresponding measured value is forwarded to the processing computer. The processing computer then controls the drives in such a way that the deflection is set which was previously measured by the distance measuring system during the first sheet pass. The set value forms a target value for the setting of the roller nip.

The transporting force of the folding rollers is a frictional force and results from the product of the perpendicular force, which is exerted on the sheets by the folding rollers, and the frictional value between the folding rollers and the sheet. The perpendicular force is determined by the deformation of the restoring springs in accordance with the ratio of the sheet thickness and the roller nip set, a perpendicular force being built up only when the roller nip is smaller than the sheet thickness. It is not directly possible here to dimension the perpendicular force necessary to drive the sheets in an optimum manner by means of setting the roller nip, and said dimensioning has to be performed by means of a correction computation, taking into account the difference between the roller nip and the sheet thickness and the spring rate of the restoring springs.

There are sheets which have a different printing profile distributed across the sheet width. For example, there can be more ink on one side than on the other side. This results in different frictional values. Moreover, the roller nips can no longer be parallel as a result of contamination of the folding rollers or wear to the roller cover. In subsequent folding units, the effective sheet thicknesses can be different for different reasons, as seen from left to right, for example as a result of dense or less dense sheet packing at the top and bottom of a prefolded sheet. For the abovementioned reasons, it can occur that the sheets are pulled obliquely through the roller nip during transport, although the identical perpendicular force is measured on both sides of the folding rollers.

### SUMMARY OF THE INVENTION

The invention is based on the object of providing a folding unit, in which the roller nip can be set and corrected automatically in a simple and precise manner.

According to the invention, this object is achieved by a folding unit comprising at least one pair of folding rollers including an adjustable folding roller and a stationary folding roller or two adjustable folding rollers, at least two pressure measuring devices being associated to one adjustable folding roller, said pressure measuring devices being arranged at a distance from one another and measuring pressure values when a sheet passes therethrough, said pressure values corresponding to pressures which are exerted on said sheet by said adjustable folding roller at two measurement points which are spaced apart transversely with respect to a sheet running direction, said pressure measuring devices forwarding measured pressure values to a processing device, each adjustable folding roller being connected kinematically to corresponding drive means at two connection points which are spaced apart transversely with respect to said sheet running direction, and said drive means being controllable by said processing device on the basis of said pressure values measured by said pressure measuring devices during said sheet pass, in order to attain an optimum roller nip width between said folding rollers.

In the folding unit according to the invention, the perpendicular forces which are necessary for driving the sheets in an optimum manner can be dimensioned by the pressure measuring devices. As a result, in particular in the case of sheets which have different frictional values across their width, it can be ensured that the sheets are not pulled obliquely through the roller nip.

The pressure measuring devices of the folding unit according to the invention can be used in combination with the folding unit known from EP 1 321 411 A1, it being advantageous in this case to arrange the pressure measuring devices between the restoring springs and the other arm of the roller lever.

In one preferred embodiment, the folding unit according to the invention has a position detection device which measures the actual position of a sheet during the sheet pass. The processing device has suitable software, using which the actual position is compared with a predefined target value. If the actual position deviates from the target value, the processing device controls the drives in such a way that the target position is attained. The pressure values which are measured by the pressure measuring devices and are measured in a correct sheet pass in which the actual position of the sheet corresponds to the target position are stored in the processing device. As a result, it is possible to set the level of the pressure values at the folding rollers in advance in an optimum manner, when identical or similar sheets are being folded.

A light sensor, for example a light curtain, which is arranged above the plane of the sheets after the folding rollers as seen in the sheet passing direction can be used, for example, as the position detection device, which light sensor is arranged above the region of a sheet edge extending in the sheet running direction and emits a voltage to the processing device as a function of the coverage by the sheet edge. It is also conceivable to use an image processing system with a camera.

### BRIEF DESCRIPTION OF THE DRAWINGS

In the following text, one exemplary embodiment of the invention will be explained in greater detail using drawings, in which:

FIG. 1 diagrammatically shows a setting device for setting an optimum roller nip between two folding rollers of a folding unit; and

FIG. 2 shows the view II—II from FIG. 1.

### DETAILED DESCRIPTION OF THE INVENTION

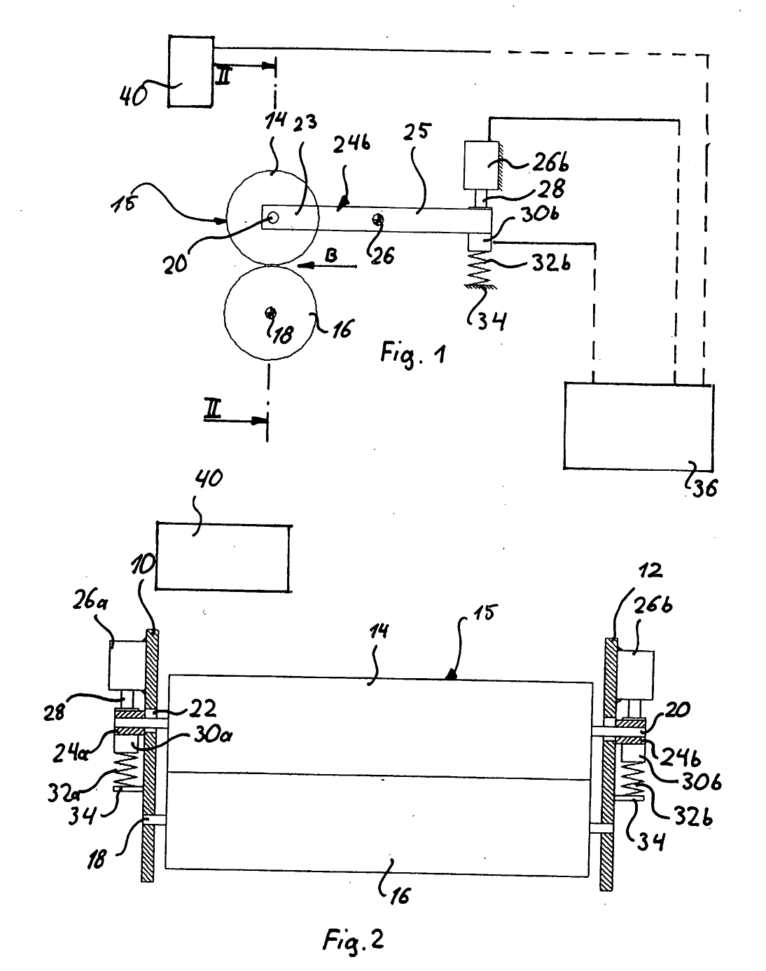

The setting device shown in FIGS. 1 and 2 for setting the width of a roller nip corresponds substantially in terms of the overall construction to the setting devices which are provided in the folding unit which is known from EP 1 321 411 A1, and by means of which setting devices the roller nip is preset, in that initially a test sheet is conveyed through the rollers, the deflection of the folding rollers is measured in the process, and the roller nip is then set in accordance with the measured values by the drives which are controlled by the processing device.

A pair of folding rollers 15 has an upper adjustable folding roller 14 and a lower stationary folding roller 16. The stationary folding roller 16 rotates about an axle 18 which is mounted nondisplaceably at its end sections in each case in a frame part 10 and 12, respectively. The adjustable folding roller 14 rotates about an axle 20 whose two end sections in each case penetrate a through opening 22 in the frame parts 10, 12, the diameter of which through opening 22 is greater than the outer diameter of the axle 20, with the result that the folding roller 14 can be adjusted upward and downward. The outer ends of the axle 20 are mounted in each case in an arm 23 of a two-armed roller lever 24a, 24b. The roller lever 24a, 24b can be pivoted about a pivot axis 26. A piston rod 28 of an adjusting drive 26a or 26b acts from above on the outer end of the other arm 25, said adjusting drive 26a or 26b being controlled by a processing device 36. A pressure sensor 30a or 30b which is in contact with other arm 25 and is pressed against the other arm 25 by a restoring spring 32a or 32b is situated on the side opposite the piston 28. The restoring springs 32a, 32b are supported, on the side opposite the pressure sensors 30a, 30b, on abutments 34 which are fastened to the frame part 10 or 12.

Provided behind the folding rollers 14, 16, in the sheet passing direction B above the sheet passing plane in the region of the left-hand edge of a passing sheet, is a light sensor 40 which is formed by a light curtain and emits a voltage to a processing computer or processing device 36 as a function of the coverage by an emerging sheet. A defined predetermined voltage corresponds to the target position of the left-hand edge of an emerging sheet. If this voltage changes during the passage of a sheet, this means that the sheet is being pulled obliquely through the folding rollers 14, 16. If the voltage is constant at the light curtain but does not correspond to the predefined target voltage, the actual position of the sheet is deviating from the target position transversely with respect to the sheet passing direction.

If a sheet is pulled obliquely through the folding rollers 14, 16, different signals are therefore passed from the light curtain 40 to the processing device 36. The processing device 36 uses these signals to evaluate by which drive 26a or 26b the pressure, that is to say the perpendicular force, on the sheet has to be increased, in order to achieve the situation where the sheet runs out of the folding rollers 14, 16 in a straight manner. The pressure sensors 30a, 30b detect the pressure value necessary for straight running and pass it on to the processing device 36. These pressure values are stored in the processing device 36. In the event of the subsequent passage of identical or similar sheets, the drives 26a, 26b are controlled by the processing device 36 in such a way that the stored pressure values are measured at the pressure sensors 30a, 30b. It is possible in this way to set the roller nip between the folding rollers 14, 16 in an optimum manner.

In the example described, the folding roller 14 is adjustable and the folding roller 16 is stationary. It is conceivable, however, for both folding rollers to be adjustable.

1. A folding unit comprising at least one pair of folding rollers including an adjustable folding roller and a stationary folding roller or two adjustable folding rollers, at least two pressure measuring devices being associated to one adjustable folding roller, said pressure measuring devices being arranged at a distance from one another and measuring pressure values when a sheet passes therethrough, said pressure values corresponding to pressures which are exerted on said sheet by said adjustable folding roller at two measurement points which are spaced apart transversely with respect to a sheet running direction, said pressure measuring devices forwarding measured pressure values to a processing device, each adjustable folding roller being connected kinematically to corresponding drive means at two connection points which are spaced apart transversely with respect to said sheet running direction, and said drive means being controllable by said processing device on the basis of said pressure values measured by said pressure measuring devices during said sheet pass, in order to attain an optimum roller nip width between said folding rollers.

2. The folding unit as claimed in claim 1, wherein each adjustable folding roller is mounted at said connection points on a first arm of a roller lever which can be pivoted about a pivot axis, corresponding drive means acting on a second arm of the roller lever, said pressure measuring devices measuring a pressure exerted by said second arm during said sheet pass.

3. The folding unit as claimed in claim 1, wherein each of said pressure measuring devices is arranged between said second arm and a first end of a restoring spring, a second end of which is supported on an abutment.

4. The folding unit as claimed in claim 1, wherein
a position detection device is provided for detecting an actual position of a sheet during said sheet pass,
the processing device is equipped in such a way that it compares said actual position with a predetermined target position and, if said actual position deviates from said target position, can control said drive means in such a way that said target position is attained, said processing device storing said pressure values measured by said pressure measuring devices when said position is attained.
